(19) United States
(12) Patent Application Publication
(10) Pub. No.: US 2004/0225977 A1
(43) Pub. Date: Nov. 11, 2004

(54) System and method for simulating clock drift between asynchronous clock domains

(76) Inventor: Ryan Akkerman, Allen, TX (US)

Correspondence Address: HEWLETT-PACKARD COMPANY, Intellectual Property Administration, P.O. Box 272400, Fort Collins, CO, 80527-2400, US

(21) Appl. No.: 10/431,823

(22) Filed: May 8, 2003

(51) Int. Cl. G06F 9/45; G06F 17/50

(52) U.S. Cl. 716/6

(57) ABSTRACT

A system and method for simulating clock drift between asynchronous clock domains. In one embodiment, a first circuit portion is positioned in a first clock domain to transmit a first data sequence. An intermediate circuit portion receives the first data sequence and, responsive to a control signal, transmits a second data sequence to a second circuit portion positioned in a second clock domain. The second data sequence is subjected to drift relative to the first data sequence.

### BACKGROUND

In previous decades, most logic design in integrated circuits (ICs) was preformed graphically using diagrams and schematics and verified by “breadboarding” the design. The increasing size, functionality and performance of ICs, time-to-market pressures, and cost constraints, however, have challenged traditional logic design. To provide ICs having increased input/output densities and complex, high pin-count packages in a constrained time period, IC logic design employs computer-aided design (CAD) software tools, also referred to as computer-aided engineering (CAE) software tools, to aid in the development of the conceptual and physical design of the IC as well as the verification of the IC.

Sophisticated CAD software tools contain component libraries and component models that describe in detail the logical and electrical operations of the digital system design of the IC. Using these models, the IC design may be verified so that various types of logic and timing errors may be found during the pre-silicon simulation phase of development.

For example, clock drift is one type of logic and timing error that needs to be modeled in the pre-silicon simulation phase. In digital circuitry, the gradual deviation from a set frequency adjustment between asynchronous clocks used to drive different clock domains over an extended period of time can lead to synchronization errors commonly referred to as clock drift. Clock drift may result in data loss, data delay, data duplication, and other types of data corruption.

Notwithstanding the advances in CAD software tools, several limitations and drawbacks continue to persist with respect to state-of-the art IC design software tools. Simulated asynchronous clock domains modeled with CAD software tools do not naturally exhibit clock drift. Cumbersome modifications to the simulated asynchronous clocks are required to simulate clock drift between asynchronous clock domains.

### SUMMARY

A system and method are disclosed that provide for simulating clock drift between asynchronous clock domains. In one embodiment, a first circuit portion is positioned in a first clock domain to transmit a first data sequence. An intermediate circuit portion receives the first data sequence and, responsive to a control signal, transmits a second data sequence to a second circuit portion positioned in a second clock domain. The second data sequence is subjected to drift relative to the first data sequence.

### BRIEF DESCRIPTION OF THE DRAWINGS

FIG. 1 depicts a functional block diagram illustrating the relationship between a digital circuit having an asynchronous clock boundary and one embodiment of a system for simulating clock drift between asynchronous clock domains;

FIG. 2 illustrates a functional block diagram of one embodiment of the system for simulating clock drift between asynchronous clock domains;

FIG. 3 illustrates a timing drawing of received data and sent data associated with a control signal of the system illustrated in FIG. 2; and

FIG. 4 depicts a flow chart of one embodiment of a method for simulating clock drift between asynchronous clock domains.

### DETAILED DESCRIPTION OF THE DRAWINGS

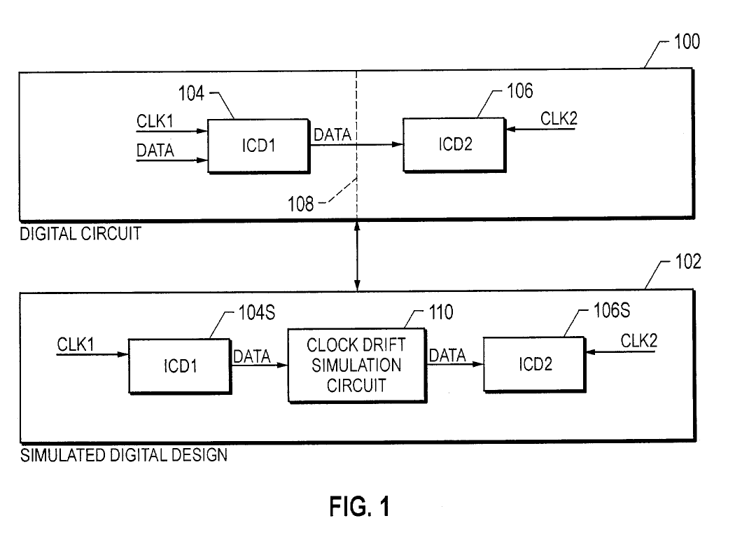

In the drawings, like or similar elements are designated with identical reference numerals throughout the several views thereof, and the various elements depicted are not necessarily drawn to scale. Referring now to FIG. 1, therein is depicted the relationship between a digital circuit 100 having an asynchronous clock boundary and one embodiment of a system 102 for simulating clock drift between asynchronous clock domains. The digital circuit 100 comprises a first integrated circuit domain 104, ICD1, driven by a first clock, CLK1, and a second integrated circuit domain 106, ICD2, driven by a second clock, CLK2. The first integrated circuit domain 104 and the second integrated circuit domain 106 may each comprise any digital logic design having any arrangement of combinational and sequential logic to effectuate any IC such as Application-Specific ICs (ASICs) or Field Programmable Gate Arrays (FPGAs), for example. As CLK1 does not equal CLK2, an asynchronous clock boundary 108 exists between the first integrated circuit domain 104 and the second integrated circuit domain 106. Hence, a data transfer from the first integrated circuit domain 104 to the second integrated circuit domain 106 may comprise a data transfer from a fast-clock-domain to a slow-clock-domain or a data transfer from a slow-clock-domain to a fast-clock-domain.

The simulated digital design system 102 models the behavior and structure of the digital circuit 100. In particular, first integrated circuit domain 104S, which is driven by the CLK1 clock, simulates the behavior and structure of the integrated circuit domain 104. Similarly, integrated circuit domain 106S, which is driven by the CLK2 clock, simulates the behavior and structure of the second integrated circuit domain 106. The simulated digital design 102 may be modeled using a design synthesis editor in a highly capable hardware-description language (HDL) environment such as a Very High Speed Integrated Circuit (VHSIC) hardware description language (VHDL) environment, a Verilog description language environment, or an Advanced Boolean Equation Language (ABEL) environment, for example. The HDL language environment provides a design, simulation, and synthesis platform wherein each constituent component within the design can be provided with both a well-defined interface for connecting it to other components and a precise behavioral specification that enables simulation. For example, the simulation may be a Verilog two-state simulation employing Gray code to analyze circuit behavior in view of synchronization errors such as clock drift. Regardless of the simulation methodology selected, however, the clock simulation enables verification that the overall behavior (i.e., input/output states, events, intermediary logic states, et cetera) of the digital circuit 100 conforms to design objectives.

As discussed in the Background, within digital circuit 100, a gradual deviation may occur between the asynchronous clocks CLK1 and CLK2 of the first integrated circuit design 104 and the second integrated circuit design 106, respectively. Over a long duration, the gradual deviation may lead to clock drift. To simulate clock drift between the integrated circuit domains 104S and 106S of the simulated digital design system 102, a clock drift simulation circuit 110 is positioned between the first integrated circuit domain 104S and the second integrated circuit domain 106S. By integrating a clock drift simulation circuit into the simulated digital design, clock drift may be modeled in the pre-silicon phase, without having to perform the cumbersome modifications to the simulated integrated circuit designs that the existing methodologies undertake.

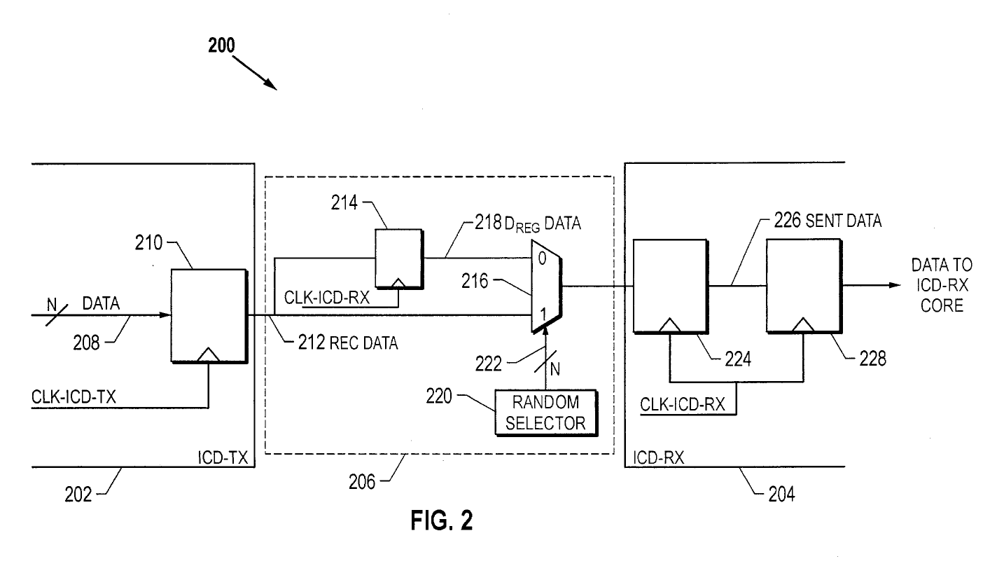

FIG. 2 illustrates one embodiment of system 200 for simulating clock drift between asynchronous clock domains 202 and 204. As will be discussed in more detail hereinbelow, a clock drift simulation circuit 206 is positioned intermediately to the circuit portion 202 and the circuit portion 204 to simulate clock drift therebetween. In the illustrated embodiment, the clock domain 202 is the transmitting integrated circuit domain (ICD-TX) and the clock domain 204 is the receiving integrated circuit domain (ICD-RX). The clock domain 202 operates with a first clock signal, i.e., CLK-ICD-TX, and the second clock domain 204 operates with a second clock signal, i.e., CLK-ICD-RX. The first and second clock signals have a ratio of N first clock cycles to M second clock cycles, wherein N does not equal M. Accordingly, the interface of the asynchronous clock domains 202 and 204 may represent either a fast-to-slow clock interface such as a core-to-bus clock interface or a slow-to-fast clock interface such as a bus-to-core clock interface. Further, in additional embodiments of the present invention, the asynchronous clock signals may have the same frequency but with a skew.

Within the first clock domain 202, an N-bit wide data path 208 provides data to a register 210 which is driven by the CLK-ICD-TX clock. It should be appreciated that if the data path is N-bit wide and N>1, then the register 210, and similarly other components of the system 200, will comprise an appropriate arrangement of N-tuple components. For example, when N>1 the clock domain 202 may comprise N registers 210 to handle the N-bit wide data path. The register 210, in turn, provides the data to the clock drift simulation circuit 206 via data path 212, which is labeled REC DATA in FIG. 2. Within the clock drift simulation circuit 206, the data path 212 provides the data to a delay register 214 and a Multiplexer (MUX) block 216. In one embodiment, the delay register is clocked by the CLK-ICD-RX clock and holds the data provided by the data path 212 for one clock cycle before transmitting the data to the MUX block 216 via data path 218 as indicated by the notation D_{REG} DATA in FIG. 2.

A random selector 220 generates an N-bit wide control signal 222 which controls MUX block 216. As illustrated, the control signal may be a randomly generated control signal. Depending on the value of the control signal 222, the MUX block 216 selects either the input data provided by data path 212 or the input data provided by data path 218 to be forwarded as output to the clock domain 204. Within the clock domain 204, the data is forwarded to register 224 and, via data SENT DATA path 226, the data is forwarded to register 228 before entering the core of the digital logic of clock domain 204. As illustrated, register 224 and register 228 are driven by the CLK-ICD-RX clock signal.

The data sequence provided by data path 226, i.e., the data within the clock domain 204, may exhibit clock drift relative to the data sequence provided by the data path 208 of the clock domain 202. For example, assuming that the data is one-bit wide, if the control signal 222 comprises “1,” then the data provided via data path 212 is forwarded to the clock domain 204. This undelayed data may be considered “fast” data that is representative of a data portion that is not affected by clock drift. If the control signal 222 comprises “0,” however, then the data provided by the delay register 214 via data path 218 is selected to be forwarded to the clock domain 204. This data has been delayed by the delay register 214 for one cycle. Hence, depending on the control signal 222, the data sequence provided via data path 208 relative to the data sequence provided via data path 226 may include synchronization abnormalities, such as fast data portions, delayed data portions, duplicate data portions, and absent data portions, for example, that are indicative of clock drift.

By way of another example, the following table illustrates the clock drift simulation circuit simulating drift for a two-bit wide data path which provides the data sequence A₁A₂B₁B₂C₁C₂D₁D₂ over four cycles:

TABLE 1
Clock Drift for Two-Bit Wide Data Path

| | DATA RECEIVED | DATA HELD | RANDOMLY | DATA SENT TO |
|---|---|---|---|---|
| | FROM FIRST | IN DELAY | GENERATED MUX | SECOND CLOCK |
| CYCLE | CLOCK DOMAIN | REGISTER | CONTROL SIGNAL | DOMAIN |
| 1 | A₁A₂ | ** | 11 | A₁A₂ |
| 2 | B₁B₂ | A₁A₂ | 01 | A₁B₂ |
| 3 | C₁C₂ | B₁B₂ | 10 | C₁B₂ |
| 4 | D₁D₂ | C₁C₂ | 00 | C₁C₂ |

For a two-bit wide data path, the randomly generated MUX control signal may have any one of four values {11, 10, 01, 00}, wherein a “1” controls the MUX block to select data received from the first clock domain and a “0” controls the MUX block to select data held in the delay register. As illustrated in Table 1, depending on the value of the MUX control signal, clock drift between the asynchronous clock domains is simulated by randomly mimicking the symptoms of clock drift, i.e., data corruption. In a system not experiencing clock drift, the data sequence A₁A₂B₁B₂C₁C₂D₁D₂ would be forwarded to the second clock domain as A₁A₂B₁B₂C₁C₂D₁D₂. However, due to the clock drift the data sequence A₁A₂A₁B₂C₁B₂C₁C₂ is forwarded to the second clock domain over four cycles, provided randomly generated control signals are applied for all cycles. The system described herein thereby effectuates clock drift by inserting a clock drift simulation circuit between the clock domains as opposed to altering the behavior of each of the clock domains using cumbersome logic combinations.

As previously mentioned, the clock drift simulation circuit 206 may be effectuated as a function modeled by a design synthesis editor in a HDL environment such as a VHDL environment, a Verilog description language environment, or an ABEL environment, for example. In one embodiment, the clock drift simulation circuit may comprise an HDL-compatible module operable to delay data crossing an asynchronous clock boundary. The following code portion may be employed in conjunction with a Verilog synthesis tool to effectuate one embodiment of the system for simulating clock drift between asynchronous clock domains:

[symbol]

ifdef REO_SIM_ONLY

| | | |
|---|---|---|
| reg [31:0] | rseed; | / / Randomly initialized seed |
| reg | enable_delay_ff; | / / Enables delay of input (external control) |
| reg [$1-1:0] | d_ff; | / / input delay 1 cycle |
| reg [$1-1:0] | delay_ff; | / / delay this cycle |
| reg [7:0] | switch_count_ff; | / / countdown to next switch of delay |

initial

begin

enable_delay_ff = 1′b0;

end

[symbol]

ifdef INITSTATE

initial

begin

$InitReg (rseed); / / Load with seed or time of day value
$InitReg (delay_ff);

end

[symbol]

endif

always @ (posedge clk) begin

| | |
|---|---|
| switch_count_ff <= [symbol] TIMENBA | (switch_count_ff = = 8′h0) ? |
| | ({$random (rseed)} %50) + 3 : |
| | switch_count_ff - 8′hl; |

| | | |
|---|---|---|
| delay_ff | <= [symbol] TIMENBA enable_delay_ff ? | ((switch_count_ff = = 8′h0) ? |
| | | $random (rseed) : |
| | | delay_ff) : $1′h0; |

| | |
|---|---|
| d_ff | <= [symbol] TIMENBA d; |
| q | <= [symbol] TIMENBA (delay_ff & d_ff) \| (˜delay_ff & d); |

end
always @ (posedge clk) begin

q <= [symbol] TIMENBA d;

end

[symbol]

endif

It should be appreciated that the code presented hereinabove is presented by way of example and not by way of limitation. Various modifications to the code may be made without departing from the teachings disclosed herein. Moreover, it should be appreciated that the digital logic within the clock drift simulation circuit 206 may be modified and still be within the teachings of the present invention. For example, delay register 214 may comprise a series of delay registers and additional MUX blocks that may delay random portions of data for one, two, or more cycles depending on randomly selected MUX control logic.

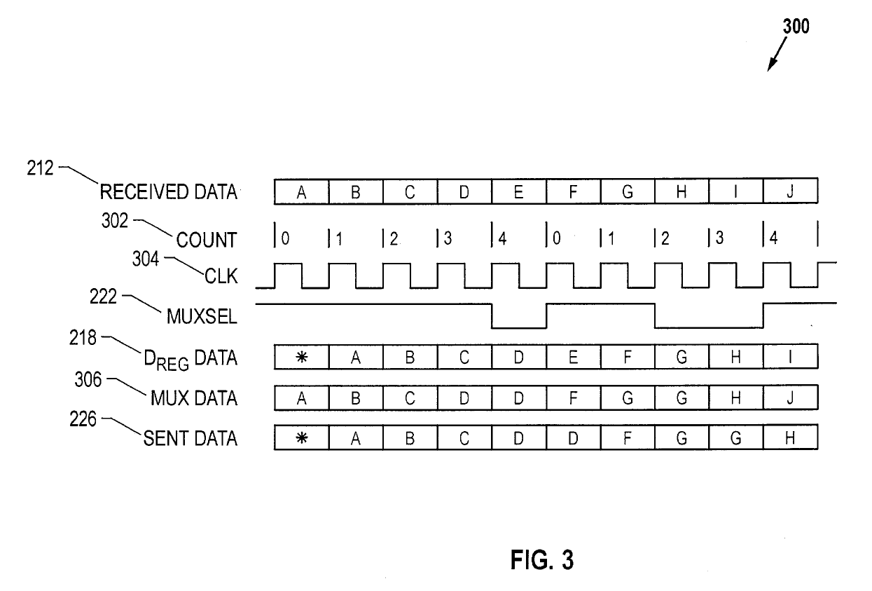

FIG. 3 illustrates a timing sequence 300 for received data and sent data associated with a control signal of the system 200 illustrated in FIG. 2. A cycle COUNT 302 refers to the numbering of CLK signals 304 in a particular transmit window of the timing sequence 300. RECEIVED DATA 212 received from the first clock domain by the clock simulation circuit is held for one cycle as D_{REG} DATA 218. A MUXSEL signal 222 controls whether the RECEIVED DATA 212 or the D_{REG} DATA 218 is transmitted as MUX DATA output 306 to the second clock domain. With reference to FIGS. 2 and 3, the MUX DATA output 306 is outputted from MUX block 216 to the register 224 of the second clock domain 204 where the data is held for one cycle. The data is then forwarded to the core of the second clock domain 204 via SENT DATA 226. Accordingly, the SENT DATA 226 comprises the MUX DATA output 306 delayed one cycle.

Referring again to FIG. 3, if the MUXSEL signal 222 is high, then the RECEIVED DATA 212 is transmitted to the second clock domain and if the MUXSEL signal 222 is low, then the D_{REG} DATA 218 is transmitted as MUX DATA output 306. As illustrated, the MUXSEL 222 is high for the first four cycles, i.e., counts 0 through 3 of COUNT 302. Accordingly, for counts 0 through 3 of COUNT 302, A, B, C, and D data blocks of the RECEIVED DATA 212 are sent to the second clock domain via MUX DATA output 306. At the fifth cycle, i.e., count 4 of COUNT 302, the MUXSEL signal 222 is low, so the D data block held in D_{REG} DATA 218 is transmitted via MUX DATA output 306. Similarly, in the next window, MUXSEL signal 222 is low during cycles 3 and 4, i.e., counts 2 and 3 of COUNT 302. This results in the G data block of D_{REG} DATA 218 being sent in count 2 and the H data block being sent in count 3 of MUX DATA output 306. Hence, the data sequence of MUX DATA output 306, i.e., ABCDDFGGHJ, exhibits clock drift. For instance, the duplicate D and G data blocks are indicative of clock drift. Likewise, the delayed H data block and dropped E and I data blocks are indicative of clock drift between the clock domains.

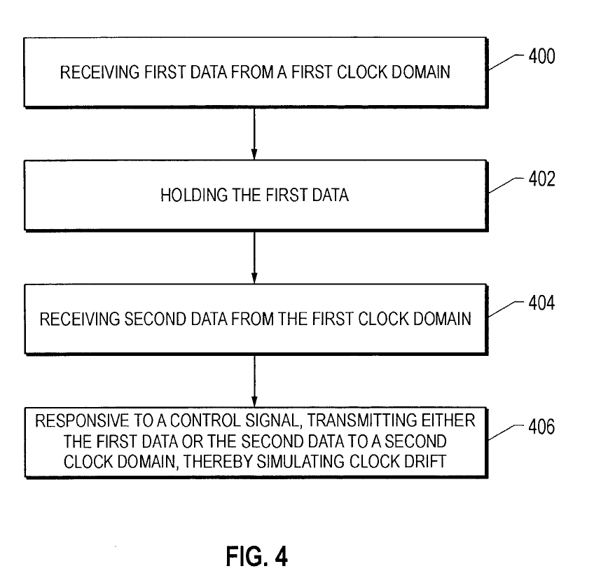

FIG. 4 depicts one embodiment of a method for simulating clock drift between asynchronous clock domains. At block 400, first data is received by a clock drift simulation circuit from a first clock domain. At block 402, the first data is held for an amount of time. In one embodiment, the first data is held for one cycle. At block 404, second data is received by the clock drift simulation circuit from the first clock domain. At block 406, responsive to a control signal, either the first data or the second data is transmitted to a second clock domain, thereby simulating clock drift. In one embodiment, the control signal comprises a randomly generated control signal which provides for a more realistic and revealing exercise of the simulated circuit design. Accordingly, the systems and methods disclosed herein simulate clock drift by inserting a clock drift simulation circuit between the clock domains that is not only less complex (because of no x or z states) but also facilitates faster simulation by using only two states.

Although the embodiments herein have been particularly described with reference to certain illustrations, it is to be understood that the forms of the invention shown and described are to be treated as exemplary embodiments only. Various changes, substitutions and modifications can be realized without departing from the spirit and scope of the invention as defined by the appended claims.

What is claimed is:

1. A system for simulating clock drift between a first clock domain and a second clock domain, wherein said first clock domain is operable with a first clock signal and said second clock domain is operable with a second clock signal, said first and second clock signals having a ratio of N first clock cycles to M second clock cycles, the system comprising:
a first circuit portion positioned in said first clock domain, the first circuit portion for transmitting a first data sequence; and
an intermediate circuit portion for receiving said first data sequence and, responsive to a control signal, transmitting a second data sequence to a second circuit portion positioned in said second clock domain, wherein said second data sequence is subjected to clock drift relative to said first data sequence.

2. The system for simulating clock drift as recited in claim 1, wherein said intermediate circuit portion comprises:
a delay register positioned in communication with said first circuit portion, said delay register operable to hold first data sequence; and
a Multiplexer (MUX) block having inputs in communication with said delay register and said first circuit portion and having an output in communication with said second circuit portion,
wherein said MUX block, responsive to said control signal, is operable to select between data provided by said delay register and said first circuit portion.

3. The system for simulating clock drift as recited in claim 1, wherein said control signal comprises a randomly generated control signal provided by a random selector.

4. The system for simulating clock drift as recited in claim 1, wherein said second data sequence comprises, relative to said first data sequence, data portions selected from the group consisting of fast data portions, delayed data portions, duplicate data portions, and absent data portions.

5. The system for simulating clock drift as recited in claim 1, wherein said first data sequence and said second data sequence comprise N-bit wide data sequences.

6. The system for simulating clock drift as recited in claim 1, wherein said first circuit portion, said intermediate circuit portion, and said second circuit portion are simulated using a Hardware Description Language (HDL).

7. The system for simulating clock drift as recited in claim 1, wherein said first circuit portion, said intermediate circuit portion, and said second circuit portion are simulated using a synthesis tool selected from the group consisting of Verilog, Very High Speed Integrated Circuit (VHSIC) Hardware Description Language (VHDL), and Advanced Boolean Equation Language (ABEL).

8. A method for simulating clock drift between a first clock domain and a second clock domain, wherein said first clock domain is operable with a first clock signal and said second clock domain is operable with a second clock signal, said first and second clock signals having a ratio of N first clock cycles to M second clock cycles, the method comprising:
receiving first data from said first clock domain;
holding said first data;
receiving second data from said first clock domain;
generating a control signal; and
responsive to said control signal, transmitting either said first data or said second data to said second clock domain, thereby simulating clock drift between said first clock domain and said second clock domain.

9. The method as recited in claim 8, wherein the operation of receiving first data from said first clock domain further comprises receiving N-bit wide first data from said first clock domain.

10. The method as recited in claim 8, wherein the operation of generating a control signal further comprises generating an N-bit wide control signal.

11. The method as recited in claim 8, wherein the operation of generating a control signal further comprises generating a random control signal.

12. The method as recited in claim 8, wherein said first data is held for one clock cycle of said second clock signal.

13. A computer-readable medium operable with a computer platform to simulate clock drift between a first clock domain and a second clock domain, wherein said first clock domain is operable with a first clock signal and said second clock domain is operable with a second clock signal, said first and second clock signals having a ratio of N first clock cycles to M second clock cycles, the computer-readable medium comprising:
instructions for receiving first data from said first clock domain;
instructions for holding said first data;
instructions for receiving second data from said first clock domain;
instructions for generating a control signal; and
instructions for transmitting, in response to said control signal, either said first data or said second data to said second clock domain, thereby simulating clock drift between said first clock domain and said second clock domain.

14. The computer-readable medium as recited in claim 13, wherein the instructions for receiving first data from said first clock domain further comprise instructions for receiving N-bit wide first data from said first clock domain.

15. The computer-readable medium as recited in claim 13, wherein the instructions for generating a control signal further comprise instructions for generating an N-bit wide control signal.

16. The computer-readable medium as recited in claim 13, wherein the instructions for generating a control signal further comprise instructions for generating a random control signal.

17. The computer-readable medium as recited in claim 13, wherein said computer-readable instructions are effectuated by instructions encoded in a Hardware Description Language (HDL).

18. The computer-readable medium as recited in claim 13, wherein said computer-readable instructions are effectuated by instructions encoded by a synthesis tool selected from the group consisting of Verilog, Very High Speed Integrated Circuit (VHSIC) Hardware Description Language (VHDL), and Advanced Boolean Equation Language (ABEL).

19. A computer system for simulating clock drift across an asynchronous clock boundary within a digital circuit, the computer system comprising:
a hardware description language (HDL) tool for modeling the structure and function of said digital circuit;
an HDL-compatible module positioned at said asynchronous clock boundary, wherein said HDL-compatible module is operable to delay data crossing said asynchronous clock boundary, thereby simulating clock drift across said asynchronous clock boundary.

20. The computer as recited in claim 19, wherein said HDL tool is employed in a two-state simulation.

21. The computer as recited in claim 19, wherein said HDL tool comprises a synthesis tool selected from the group consisting of Verilog, Very High Speed Integrated Circuit (VHSIC) Hardware Description Language (VHDL), and Advanced Boolean Equation Language (ABEL).

22. The computer as recited in claim 19, wherein said HDL-compatible module is operable to randomly insert delay into said data crossing said asynchronous clock boundary.
